(19) United States
(12) Patent Application Publication
(10) Pub. No.: US 2012/0233666 A1
(43) Pub. Date: Sep. 13, 2012

(54) Network-Oriented Matrix Sharing For Genealogy And Social Networks Through Network-Role-Based Access Controls

(76) Inventor: Sheng-He Gu, Madison, WI (US)

(21) Appl. No.: 13/416,626

(22) Filed: Mar. 9, 2012

Related U.S. Application Data
(60) Provisional application No. 61/450,903, filed on Mar. 9, 2011.

(51) Int. Cl. G06F 21/20

(52) U.S. Cl. 726/4

(57) ABSTRACT

A computer-implemented method for displaying social media content items using a network based browser. The method includes displaying a plurality of networks from a social media content database, the database including social media content items organized into networks, receiving a selection of a network from the plurality of networks from a user, comparing access control information for the selected network including determining role types authorized to view social media content items in the network to a role type associated with the user for that network, identifying a plurality of social media content items that can be displayed on the comparison, and displaying the identified social media content items.

### CROSS-REFERENCE TO RELATED APPLICATIONS

This application claims the benefit of U.S. Provisional Application No. 61/450,903, filed Mar. 9, 2011, the entirety of which is hereby incorporated by reference.

### FIELD OF INVENTION

This invention generally relates to social networking, specifically to the network-oriented matrix sharing among genealogy and social networks through network-role-based access controls.

### BACKGROUND OF THE INVENTION

Social networks are increasingly popular for sharing information with family and friends. Typically, social network users provide some type of social media content item, including, for example documents, text, pictures, videos, etc. to be shared with social network members that are associated with them. Social networks generally require a handshake between users associated with two different user Ms before allowing users to see each other's social media content items. Accordingly, a social network browser is often required to determine which social media content items are to be shown to a current user.

In these social networks, subject ids, e.g. “profileID” and “groupID”, are, usually used to browse a person or a group, and the user IDs are also used to identify a relationship between a subject and a user. This sharing type is defined as a linear sharing here. For example, on Facebook, all social relationships are defined to be friends, or friends' friends, and even for a user' parents, grand parents, or children, grand children, they have to be pushed into the relationships of friends or friends' friends. Thereafter, the linear relationship is used for access controls. If a user wants to share something with his/her groups in Facebook, he/she has to add his/her group members to be his/her friends. On LinkedIn, the type of the linear sharing is defined as a “connection.” Both of these connections are either the first-level connected (shown to a first user based on a specific handshake between the first and a second user) or the second-level connected (shown to a first user based on a specific handshake between the a second user and a third user and an indication from the second user that this type of information should be shared in a call).

In genealogy social network applications, for example, such as ancestry.com and geni.com, information sharing is performed strictly based on the userID existing in a family tree hierarchy. In this case, the linear sharing is defined the relationship among families and family trees. As a result, users are not able to provide social sharing outside of the rigidly defined family tree. For example, a user of a traditional genealogy social network application is not provided with an interface that allows them to browse or access items from their parent's friends or colleague groups. Similarly, a user of a traditional genealogy social network application is not provided with an interface that allows them to see their children classes and classmates from their family tree.

What is needed is a system and method for providing network-oriented matrix sharing and network-role-based access controls providing interconnections between genealogy and social networks. What is further needed is a social network browsing application allowing the users to navigate multiple networks of social media content items organized in a hierarchical framework based on their defined role within each network.

### SUMMARY

According to one embodiment of the invention, network-oriented matrix sharing and network-role-based access controls are, provided for a user's interconnections between genealogy and social networks.

From a user's families and family tree relationships (user—family tree—friend/group), the invention gives easy and secure way to explore each network from families and family tree. A user can explore each family and family members from his/her family tree, e.g. his/her grand-grand ancestors or grand-grand descendants. He/she can also explore his/her family members' friends and groups from his/her family tree.

From a user's friend relationships (user—friend—family/friend/group), the invention gives an easy and secure way for a user to, explore his/her friends, his/her friends' friends, his/her friends' families/family members, and his/her friends' groups/group members,

From a user's group relationships (user—group—family/friend/group), this invention also gives an easy and secure way for a user to explore his/her groups/group members, his/her group members' groups/group members, his/her group members' friends, and his/her group members' families/family members.

Based on this network-oriented social networking architecture, it is also easy to implement other fellowships, for example, academic genealogy (user—academic genealogy—family/friend/group).

According to another embodiment, the present invention includes a computer-implemented social network system configured to display content based on a user role within a network. The system includes a social media content database, the database including social media content items organized into networks, an access control system configured to set access control for the plurality of networks in the social media content database based on a user role within the network and a a social network content display server. The display server is configured to receive a user ID, receive a selection of a network, determine a user role associated with the user ID for the selected network, and display social'media content items from the social media content database, associated with the selected network where the access control, system based on the access control setting for the user role associated with the selected network.

In one embodiment, the selection of a network is a network selected from a plurality of networks associated with the received user ID. Social media content items may be associated with a plurality of networks, the, plurality of networks being organized into a hierarchy data structure configured to define a parent node associated with the first user, a first tier node associated with at least a first tier user that has accepted an invitation from the first user, and a second tier node associated with a second tier user that has accepted an invitation from the second user.

In another embodiment, the access control system is configured to set a unique access control setting for the user role for each tier in the hierarchy data structure and the network is a genealogical network including a plurality of user IDs organized into a family tree. The social media content database may also be configured to include a definition of relationships between the networks and the social network content display server is further configured to display networks having a relationship with the selected network in an interface accompanying the display of the social media content items.

According to another embodiment, the present invention includes a computer-implemented social network media sharing method configured to display content based on a user role within a network. The method includes receiving a user ID, receiving a selection of a network, determining a user role associated with the user ID for the selected network, identifying social media content items associated with the selected network from a social media content database having access control settings that permit display of the social media content items for the user role and displaying the identified social media content.

According to another embodiment, the present invention includes a computer-implemented method for displaying social media content items using a network based browser. The method includes displaying a plurality of networks from a social media content database, the database including social media content items organized into networks, receiving a selection of a network from the plurality of networks from a user, comparing access control information for the selected network including determining role types authorized to view social media content items in the network to a role type associated with the user for that network, identifying a plurality of social media content items that can be displayed on the comparison, and displaying the identified social media content items.

One feature of this embodiment is configured such that the displayed plurality of networks is associated with the received user ID. Another embodiment is configured such that the displayed plurality of networks includes at least a personal network, a family network, and a group network. Displaying the family network can include displaying family tree information in a genealogical configuration.

One feature of this embodiment such that displaying a plurality of networks includes displaying relationships between networks within the plurality of networks and further displaying a plurality of networks having a relationship with the selected network in an interface accompanying the display of the identified social media content items.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a social networking environment for sharing social media content items over a computer network, such as the Internet, from a social network content display server, according to an exemplary embodiment;

FIG. 2 is a block diagram illustrating a communication process that may be performed by the web server of FIG. 1 to create a user account and configure user access control settings, according to an exemplary embodiment;

FIGS. 3A-3C are an access control setting web pages used to define permissions for viewing a user's uploaded social media content items for target networks stored within the database of FIG. 1, according to an exemplary embodiment;

FIG. 4 is a flowchart illustrating a method for network based browsing of social media content items using a browsing application to access the social media content server of FIG. 1, according to an exemplary embodiment;

FIGS. 5A-5C are flowcharts illustrating methods for identifying social media content items in a database that can, be viewed based on a user's role within a network, according to an exemplary embodiment; and

FIGS. 6A-6C, are flowcharts illustrating methods for loading a network associated with a plurality of social media content items including relationships to at least one other network, according to an exemplary embodiment.

Before the embodiments of the invention are explained in detail, it is to be understood that the invention is not limited in its application to the details of construction and the arrangement of the components set forth in the following description or illustrated in the drawings. The invention is capable of other embodiments and, of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION

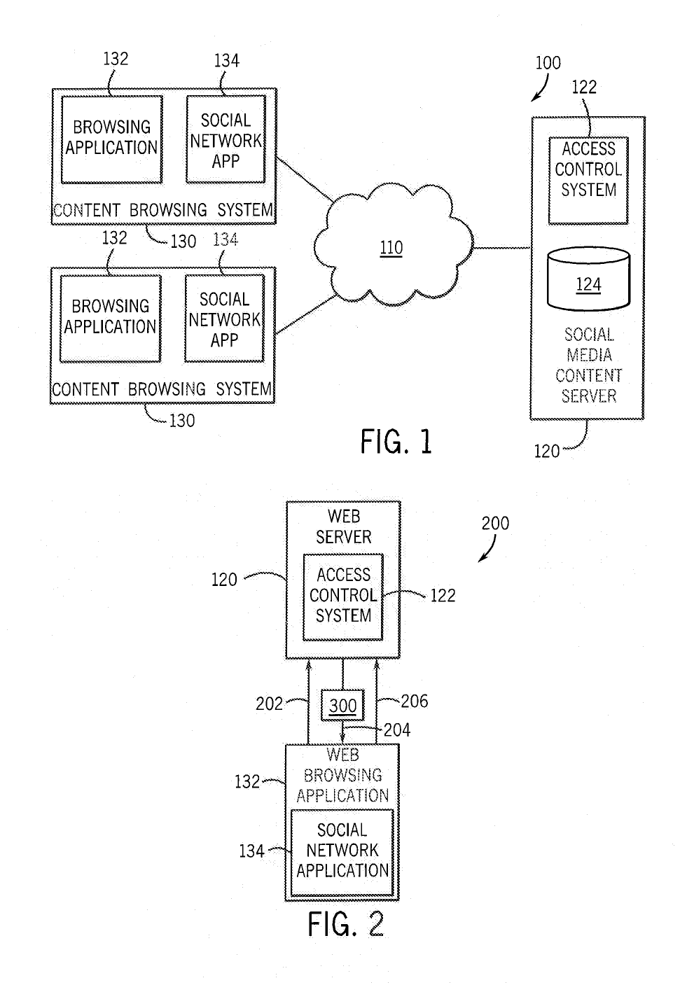

Referring now to FIG. 1, a social networking environment 100 for sharing social media content items over a computer network 110, such as the Internet, from a social network content display server 120 is shown, according to an exemplary embodiment. Environment 100 includes a plurality of content browsing systems 130 configured to download social media content items from social network content display server 120 over computer network 110.

Social network content display server 120 may be a server that allows users to access server 120, such as by using a web browser or dedicated social network application, to download social media content items for display on their content browsing system 130. Generally speaking, social network content display server 120 is configured to maintain a plurality of user accounts, each user account associated with a unique user ID, Users, seeking a user account on server 120, utilize their content browsing system 130 to access server 120, provide personal information to be associated with their user account, provide a password or other security information to be associated with the user account, provide a initial listing of friends or family to be associated with their user account, as well as other social networking activities as are well known in the art. Thereafter, users utilize content browsing systems 130 to access server 120 to download social media content items associated with the user accounts of those provided friends or family that are is associated with their user account. Users may further upload their own social media content items to server 120 to allow other users to view their social media content items

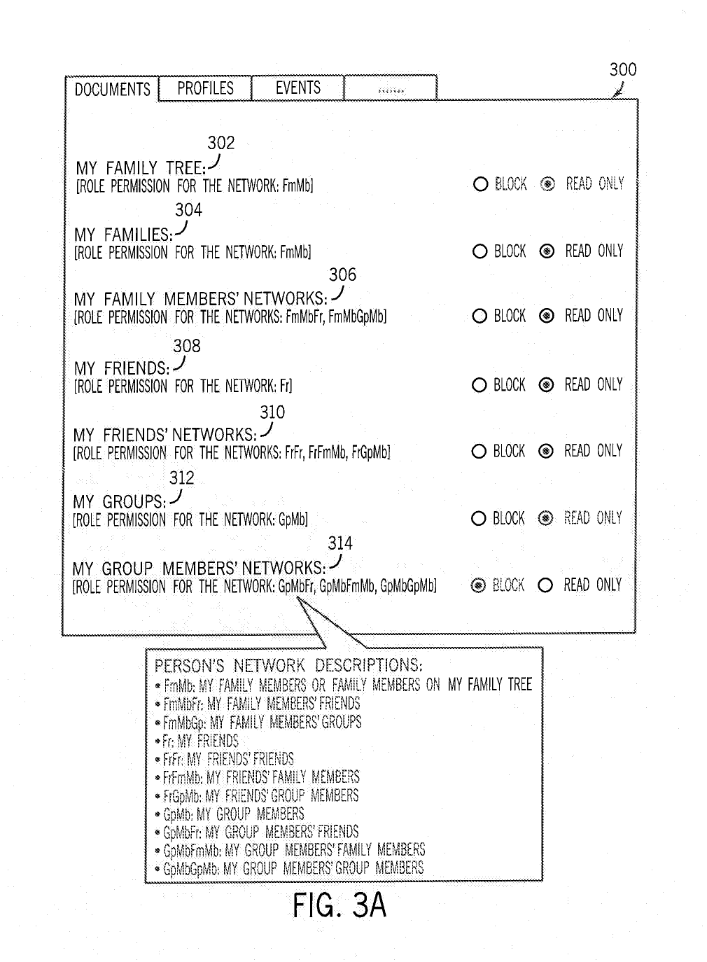

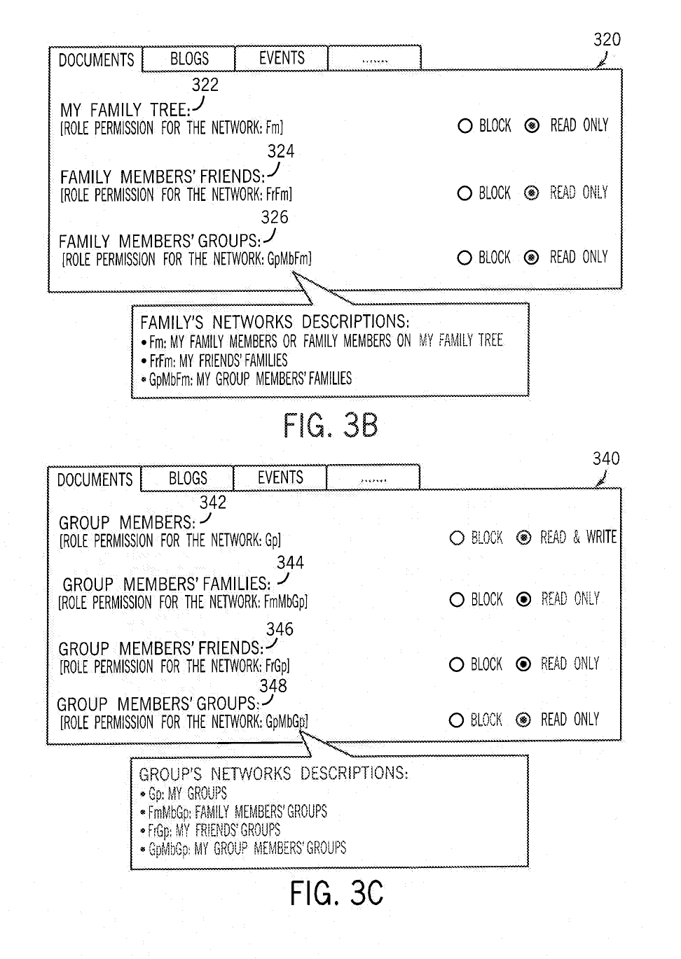

Social network content display server 120 includes a access control system 122 configured to implement an access control function to limit the display of social media content items to specific identified user IDs, based on network-oriented matrix sharing and network-role-based access controls, as further described hereinbelow with reference to FIGS. 3A-8.

Social media content servicer 120 further includes a social media content database 124. Database 124 is configured to include a plurality of social media content items. Each item may be associated with one or more network and be associated with a set of role base permissions within each network, as described in detail below with reference to FIGS. 3A-3C.

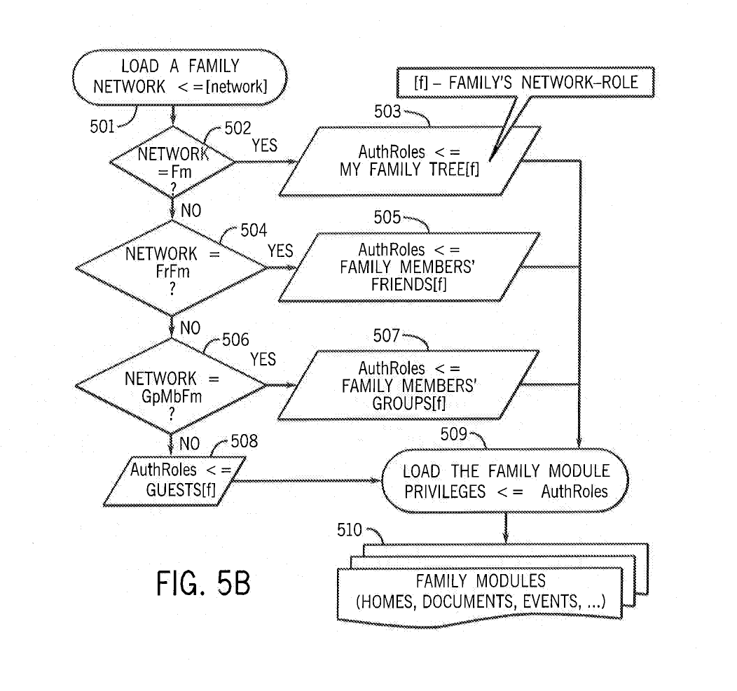

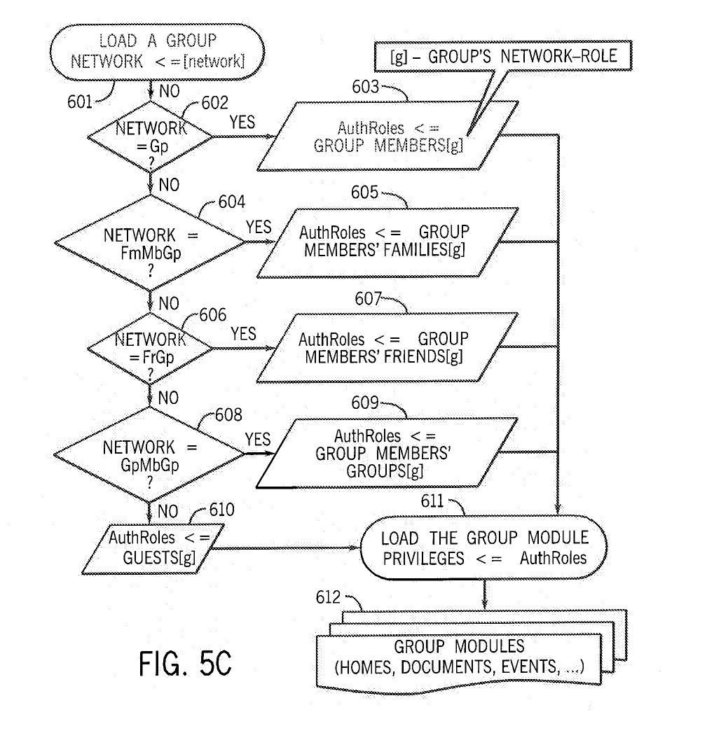

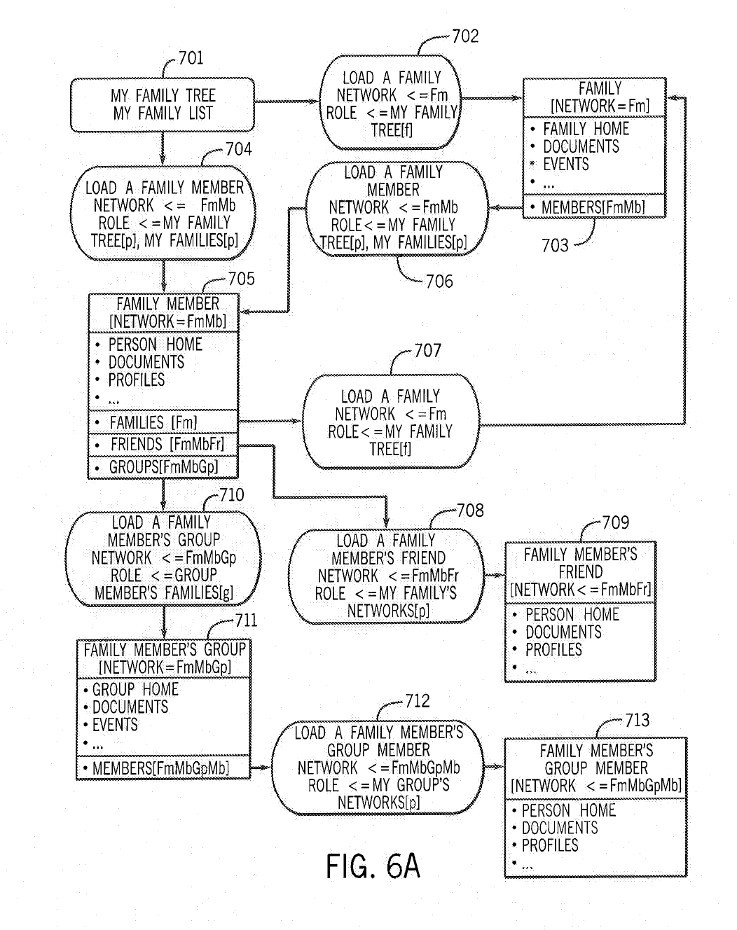

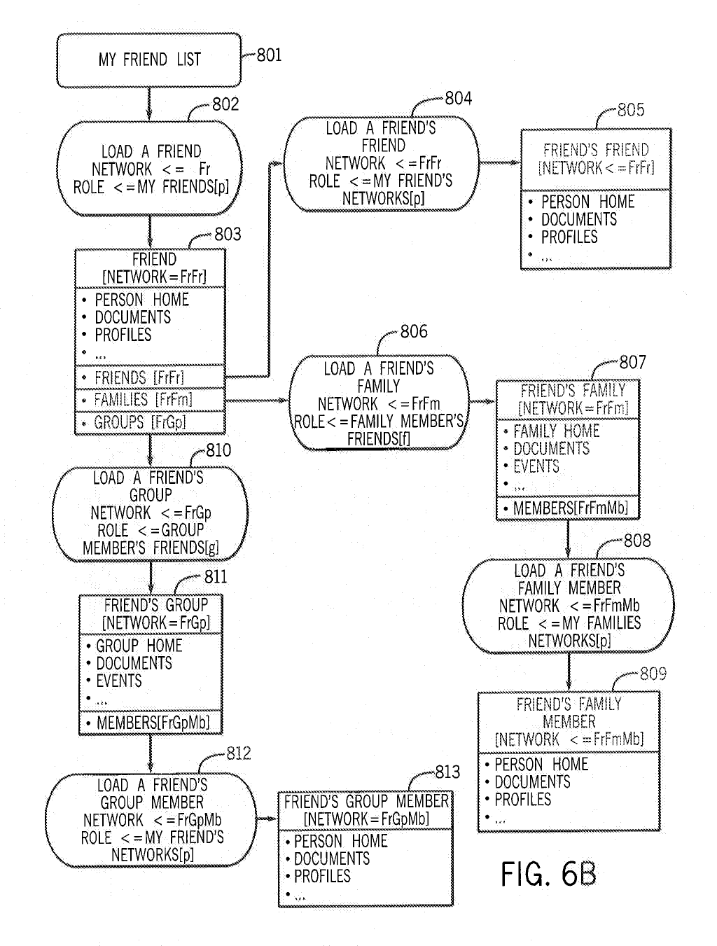

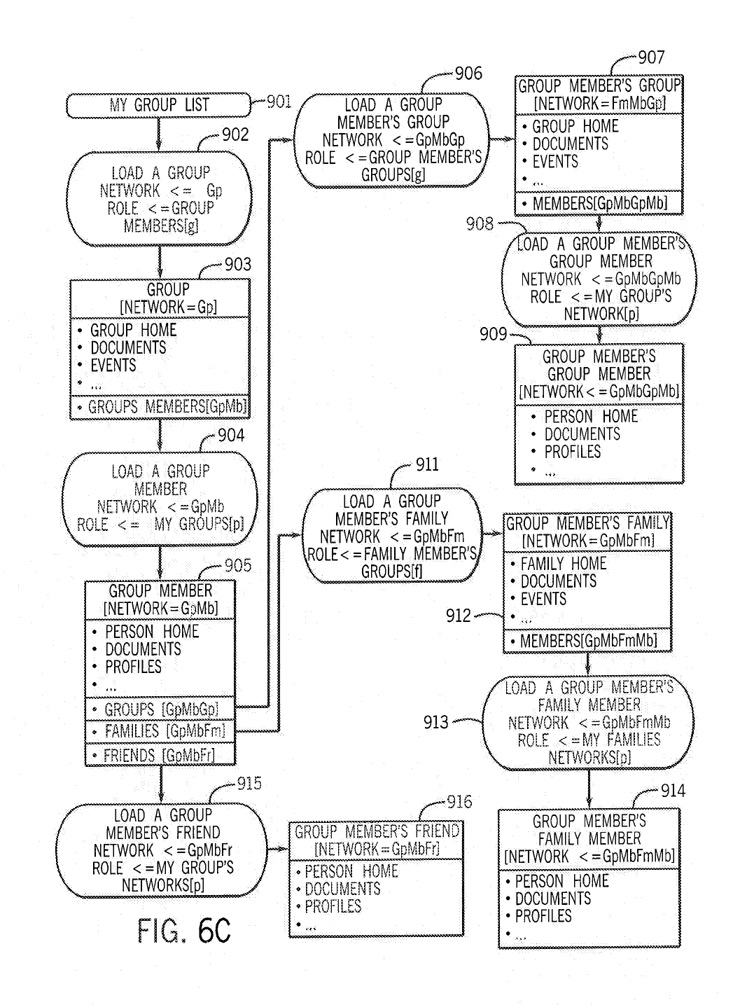

Social network display server 120 is a one or more standard server computer systems configured to allows a user of a content browsing system 130 to log onto server 120 using, for example, a user ID and password. Once the user is authenticated and logged into the server 120, the user can, then access some social media content items downloadable through server 120. The social media content can be provided using a network based browsing method in which server 120 receives a selection of a network, determines the role of the user within that network, as described below with reference to FIGS. 5A-5C and begins network based browsing of social media content, as described below with reference to FIGS. 6A-6C.

Database 124 may be used to store and allow retrieval of social media content information organized into particular networks. Further, each network in database 124 includes a defined relationship to a least one other network with database 124. Access to the items in the networks may be controlled by server 120 based on user role information from access control system 122. In accordance with one embodiment of the present invention, database 124 includes a network-oriented matrix for storing social media content items among friends, families and groups through genealogy and social networks by network-role-based access controls implemented by system 122. Exploring social networks by pre-defined networks instead of subject IDs will enhance current linear sharing to matrix sharing among family tree and social networks.

Access control settings page can be used to define access control settings based on genealogy and social relationships among families, and friends and, groups. Accordingly, database 124 includes the following networks: From my families and family tree (a person to family tree relation), database 124 includes five relationships and their responding networks:

1. A family on my family tree, including my families; (Network=Fm)

2. A family member on my family tree; (Network=FmMb)

3. The family member's friends; (Network=FmMbFr)

4. The family member's groups; (Network=FmMbGp)

5. The family member's group members; (Network=FmMbGpMb)

From my friends (a person to a person relationship), database 124 includes six relationships and their responding networks:

1. My friends; (Network=Fr)

2. My friends' friends; (Network=FrFr)

3. My friends' families; (Network=FrFm)

4. My friends' families' members; (Network=FrFmMb)

5. My friends' groups; (Network=FrGp)

6. My friends' groups' members; (Network=FrGpMb)

From my groups (a person to a group relationship), database 124 seven relationships and their responding networks:

1. My groups, e.g. my classmates' groups; (Network=Gp)

2. My group members; (Network=GpMb)

3. My group members' families; (Network=GpMbFm)

4. My group members' families' members; (Network=GpMbFmMb)

5. My group members' friends; (Network=GpMbFr)

6. My group members' groups; (Network=GpMbGp)

7. My group members' group members; (Network=GpMbGpMb)

Content browsing system 130 is a standard computing device including a web browsing application 132 and/or a social network browsing application 134. System 130 be implemented using a number of different types of computing systems such as desktop computing systems, laptop computing systems, handheld computing systems, smartphone based computing systems, etc. Content browsing system 130 may be a typical computing device including a processor connected via an internal bus with a memory including, for example, volatile random access memory and nonvolatile mass storage memory such as flash memory or a hard disk drive. The bus may also communicate with one or more interfaces communicating respectively with a network media, for example a wired or wireless network port to connect to network 110, a keyboard, a mouse, a microphone, a camera, a speaker, a touchscreen interface, etc.

Referring now to FIG. 2, a block diagram illustrating a communication process 200 that may be performed by web server 120, access control system 122, web browsing application 132, and social network browsing application 134 when the user of system 130 create a user account with server 120 is shown, according to an exemplary embodiment. Initially, social network browsing application 134 and/or browsing application 132 may be used to send user information to server 120 to request the creation of a user account in a step 202. Social network browsing application 134 may, alternatively or additionally, be implemented as a plug-in for browsing application 132. In such a case, social application 134 may be implemented when browsing application 132 is used to access server 120.

Once application 134 creates a user account on server 120, server 120 sends a response back to application 134 indicating that the login was successful. Browsing application 132 then requests the access control settings page, further described below with reference to FIGS. 3A-3C from server 120. Server 120 returns an access control setting web page 300 to browsing application 132. Using the access control setting web page 300, the user can define access control settings describing the access that will be granted to other users to social, media content uploaded to server 120 by the user based on role information within defined networks for those other users.

Server 120 then generates an account for the user associated with a specific userID and having control settings received in a step 206. Thereafter, when browsing application 132 is used to access server 120 and access particular networks, a role determination step is performed as described in steps 5A-5C for that assigned User ID.

Referring now to FIG. 3A, an access control setting web page 300 used to define permissions for viewing a user's uploaded social media content items for target networks stored within database 124 is shown, according to an exemplary embodiment. Based on the networks in database 124, settings web page 300 may be used to define network-roles and their target networks for access controls for a user's personal network-roles and their target networks:
My family tree (target network: “FmMb”) 302
My families (target network: “FmMb”) 304
My families' networks (target networks: “FmMbFr”, “FmMbGpMb”) 306
My friends (target network: “Fr”) 308
My friends' networks (target networks: “FrFr” “FrFmMb”, “FrGpMb”) 310
My groups (target network: “GpMb”) 312
My groups' networks (target network: “GpMbFr”, “GpMbFmMb”, “FpMbGpMb”) 314

Referring now to FIG. 3B, a family network setting web page 320 may be used to define family's network-roles and their target networks:
Family tree (target network: “Fm”) 322
Family members' friends (target network: “FrFm”) 324
Family members' groups (target network “GpMbFm”) 326

Referring now to FIG. 3C, a group network setting web page 340 may be used to define group's network-roles and their target networks: (See FIG. 3)
Group members (target network: “Gp”) 342
Group members' families (target network: “FmMbGp”) 344
Group, members' friends (target network: “FrGp”) 346
Group members' groups (target network: “GpMbGp”) 348

The information in settings pages 300, 320 and 340 may, be, transmitted from browsing application 132 to server 120. Access control system 122 is configured to utilize the received settings information to determine a user's role and to control access to social media content items within networks as further described below.

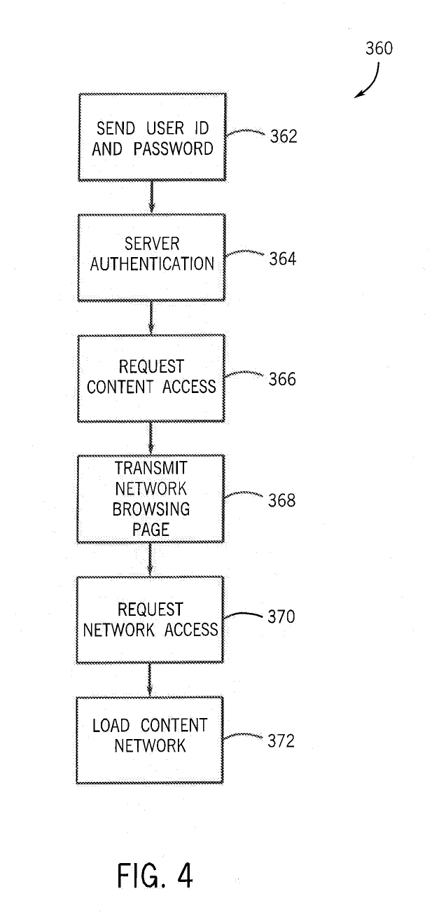

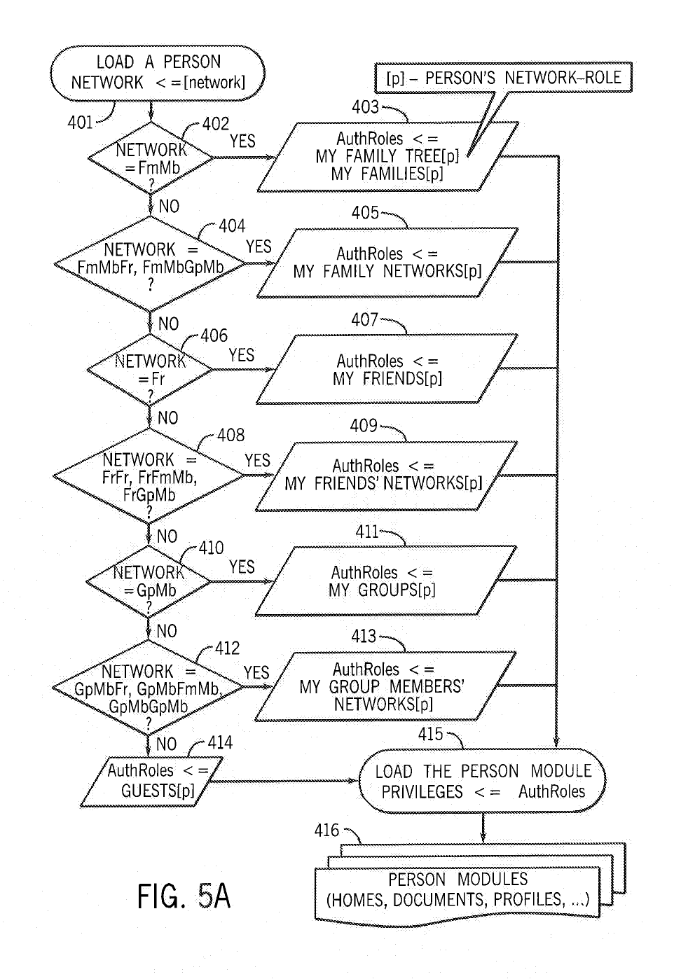

Referring now to FIG. 4, a flowchart 360 illustrating a method for network based browsing of social media content items using a browsing application 132 to access server 120 is shown, according to an exemplary embodiment. With the networks defined above in database 124 and the network-role-based access controls for person, family and group implemented in access control system 122, server 120 is used to implement matrix sharing among families, friends and groups.

In flowchart 360, a user that is already register with server 120 that has previously defined their role based network access controls using pages 300, 320 and 340, logs into server 120. To do so, social media application 132 sends the user ID and password for the user of system 130 to server 120 in a step 362 and, if proper, server 120 grants access in a step 364. In a step 366, the user requests access to networks stored within database 124. Server 120 is configured to transmit a network based social media content browsing page to browsing application 132 in a step 368.

Network based browsing includes displaying a hierarchy of networks in a web page and receiving browser input commands to navigate through networks based on relationships between the networks. For example, three scenarios for matrix sharing are shown herein to illustrated network based browsing. As shown in FIG. 6A and described in further detail below, from a “my families and family tree” network, a user can explore a family “Fm” or family members “FmMb”, family members' friends “FmMbFr”, and family members' groups “FmMbGp”/group members “FmMbGpMb.” As shown in FIG. 7B and described in further detail below, from a “my friends” network a user can explore my friends “Fr”, my friends' friends “FrFr”, my friends' family “FrFm”/family members “FrFmMb”, and my friends' groups “FrGp”/group members “FrGpMb.” As shown in FIG. 6C and described in further detail below, from a “my groups” network, a user can explore my groups “Gp” and group members “GpMb”, my group members' friends “GpMbFr”, my group members' family “GpMbFm”/family members “GpMbFmMb”, and my group members' groups “GpMbGp”/group members “GpMbGpMb.”

In, a step 370, server 120 receives an request to access a network and determines whether the user has permission for access that network based on role information for that user implemented by access control system 122. For example, referring now to FIG. 5A, where server 120 receives a request to load a person network including a plurality of social media content items in a step 401. Accordingly, server 120 determines which modules 416 representing social media content item are available based on the user's role information as determined in step 401-414 and further described below. Referring now to FIG. 6B, where server 120 receives a request to load a family network including a plurality of social media content items in a step 501. Accordingly, server 120 determines which modules 510 representing social media content item are available based on the user's role information as determined in step 501-509 and further described below. Referring now to FIG. 5C, where server 120 receives a request to load a family network including a plurality of social media content items in a step 601. Accordingly, server 120 determines which modules 612 representing social media content item are available based on the user's role information as determined in step 601-611 and further described below.

In a step 372, based on the request received in step 370, server 120 load a network associated with person, family or group. Referring now to FIG. 6A and FIGS. 5A-5C, from my family list or family tree 701, a user can load a family 702, 707 from the family list or family tree, and system will assign the family to “Fm” network 702, 707. And the user will be given family privacy role/privileges of “My family tree” 501, 502, 503 from the family. If the user is a member of the family, he/she will also be flagged as a member privilege. Then the user can explore all of authorized family modules 509, 510, 703 based on privileges per module on the family privacy role.

Then the user can load a family member either from his/her family tree 701, my family list 701, or family's members 703. When the family member is loaded 704, 706, the system will assign to the family member to “FmMb” network 704, 706, and the user will also be given the person privacy role/privileges of “My family tree” 401, 402, 403 from the family member. He/she will also be assigned the person privacy role of “My families” 403 if he/she has direct family member relationship with the person beyond ancestry relationship. Then the user can explore all authorized person modules 415, 416, 705 on this family member based on privileges per module for person privacy roles.

When the user loads one of friends from the family member 705, 708, system will assign the friend to “FmMbFr” network 708, and the user will also be assigned the person privacy role/privileges of “My families' networks” 401, 404, 405 from the friend. Then the user can explore all authorized modules 415, 416, 709 on the family member's friend based on the privileges per module on the person privacy role.

When the user loads one of the groups from the family member 705, 710, system will assign the group to “FmMbGp” network 710, and the user will be assigned the group privacy role/privileges of “Group member's families (family tree)” 601, 604, 605 from the group. Then the user can explore all authorized modules 611, 612, 711 of the group based on the privileges per module on the group privacy role.

When the user loads a group member, e.g. fathers' classmate, from the members of the group 711, 712, system will assign the group member to “FmMbGpMb” network 712. And the user will be assigned the person privacy role/privileges of “My groups' networks” 401, 404, 405 from the group member (FIG. 1). Then the user can explore all authorized modules 415, 416, 713 from the person based on the privileges per module on the person privacy role.

Referring now to FIG. 7B and FIGS. 5A-5C, From my friend list 801, a user can load a friend from the friend list 802, and system will assign the friend to “Fr” network 802, and also the user will be given the person privacy role/privileges of “My friends” 401, 406, 407 from the friend. Then the user can explore all authorized modules 415, 416, 803 from the friend under the privileges per module for the privacy role.

From the friend's friend list 803, the user can load a friend 804 from the friends' friend list, and system will assign the friend's friend to “FrFr” network 804, and also the user will be given a person privacy role/privileges of “My friends' networks” 401, 408, 409 from the friend's friend. Then the user can explore all authorized modules 415, 416, 805 from the friend's friend under the privileges per module for the privacy role.

From the friend's family list 803, the user can load a family 806 of the, friend, and system will assign the friend's family to “FrFm” network 806, and the user will be given a family privacy role/privileges of “Family member's friends” 501, 504, 505 from the friend's family (FIG. 2). Then the user can explore all authorized modules 509, 510, 807 from the friend's family under a privilege per module for the privacy role.

From the friend's family members 807, e.g. my friend's husband or wife, the user can load a family member 808 of the friend's family, and system will assign the family member to “FrFmMb” network 808, and the user will be given a person privacy role/privilege of “My Family's networks” 401, 408, 409 from the family member. Then the user can explore all authorized modules 415, 416, 809 from the friend's family member under a privilege per module for the person privacy role.

From the friend's groups 803, the user can load a group 810, e.g. a church, of the friend, and the system will assign the group to the “FrGp” network 810, and the user will also be given the group privacy role/privilege of “Group member's socials” 601, 606, 607 from the friend group (FIG. 3). Then the user can explore all authorized modules 611, 612, 811 from the friend group under a privilege per module for the group privacy role.

From the friend's group members 811, the user can load a group member 812, e.g. church fellowship, of the friend, and system will assign the friend's group member to the “FrGpMb” network 812, and the user will be given the person role/privilege of “My friend's networks” 401, 408, 409 from the group member. Then the user can explore all authorized modules 415, 416, 813 from the friend's group member under a privilege per module for the person privacy role.

Referring now to FIG. 6C and FIGS. 5A-5C, from my group list 901, a user can load a group 902, e.g. my church, from the, group list, and system will assign the group to the “Gp” network 902, and the user will be given the group role/privilege of the “Group members” 601, 602, 603 from the group. Then the user can explore all authorized modules 611, 612, 903 from the group under the privilege per module for the group privacy role.

From my group member list 903 under my group, the user can load a group member 904, e.g. my church fellowship, from the list, and system will assign the group member to the “GpMb” network 904, and the user will be given a person privacy role/privilege of “My groups” 401, 410, 411 from the group member. Then user can explore all authorized modules 415, 416, 905 from the group member under the privilege per module for the person privacy role.

From my group member's group list 905, the user can load a group 906, e.g. my church fellowship's colleague group, from the group list, and system will assign the group member's group to the “GpMbGp” network 906, and the user will be given the group privacy role of “Group members' socials” 601, 608, 609 from the group. Then the user can explore all authorized modules 611, 612, 907 from the group under the privilege per module for the group privacy role.

From my group member's group members 907, the user can load a group member 908, e.g. my church fellowship's classmate, from the group member list, and the system will assign the group member's group member to the “GpMbGpMb” network 908, and the user will be given the person privacy role/privilege of the “My groups' networks” 401, 412, 413 from the group member. Then the user can explore all authorized modules 415, 416, 909 from the group member under the privilege per module for the person privacy role.

From my group member's family list 905, the user can load a family 911, e.g. my church fellowship's family, from the family list, and system will assign the family to the “GpMbFm” network 911, and the user will be given the family privacy role/privilege of the “Family member's groups” 501, 506, 507 from the family (FIG. 2). Then the user can explore all authorized modules 509, 510, 912 from the family under the privilege per module for the family privacy role.

From my group member's family members 912, the user can load a family member 913, e.g. my church fellowship's husband or wife, from the family member list, and the system will assign the family member to the “GpMbFmMb” network 913, and the user will be given the person privacy role/privilege of the “My group members' networks” 401, 412, 413 from the family member. Then the user can explore all authorized modules 415, 416, 914 from the family member under the privilege of each module for the person privacy role.

From my group member's friends 905, the user can load a friend 915 from the friend list, and system will assign the friend to the “GpMbFr” network 915, and the user will be given the person privacy role/privilege of the “My group members' networks” 401, 412, 413 from the friend (FIG. 1). Then the user can explore all authorized modules 415, 416, 916 from the group member's friend under the privilege of each module for the person privacy role.

Certain terminology is used herein for purposes of reference only, and thus is not intended to be limiting. For example, terms such as “patient device” refer to any computing system. Terms such as program, interface, workstation and intended to provide contextual information for understanding, the type of computing systems that may be used to implement the concepts described herein and are not intended to limit the present invention to specific hardware implementations. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to, be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a server” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network. It should be understood that a computer program may embrace constituent programs and that multiple programs may be implemented as a single or multiple programs.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A computer-implemented social network system configured to display content based on a user role within a network, comprising
a social media content database, the database including social media content items organized into networks;
an access control system configured to set access control for the plurality of networks in the social media content database based on a user role within the network;
a social network content display server configured to
receive a user ID,
receive a selection of a network,
determine a user role associated with the user ID for the selected network, and
display social media content items from the social media content database associated with the selected network where the access control system based on the access control setting for the user role associated with the selected network.

2. The system of claim 1, where the selection of a network is a network selected from a plurality of networks associated with the received user ID.

3. The system of claim 1, wherein each social media content is associated with a plurality of networks, the plurality of networks being organized into a hierarchy data structure configured to define a parent node associated with the first user, a first tier node associated with at least a first tier user that has accepted an invitation from the first user, and a second tier node associated with a second tier user that has accepted an invitation from the second user.

4. The system of claim 3, wherein the access control system is configured to set a unique access control setting for the user role for each tier in the hierarchy data structure.

5. The system of claim 4, wherein the network is a genealogical network including a plurality of user IDs organized into a family tree.

6. The system of claim 1, wherein the social media content database further includes a definition of relationships between the networks.

7. The method of claim 1, wherein the social network content display server is further configured to display networks having a relationship with the selected network in an interface accompanying the display of the social media content items.

8. A computer-implemented social network media sharing method configured to display content based on a user role within a network, comprising
receiving a user ID
receiving a selection of a network;
determining a user role associated with the user ID for the selected network;
identifying social media content items associated with the selected network from a social media content database having access control settings that permit display of the social media content items for the user role; and
displaying the identified social media content.

9. The method of claim 8, where the selection of a network is a network selected from a plurality of networks associated with the received user ID.

10. The method of claim 8, wherein each social media content is associated with a plurality of networks, the plurality of networks being organized into a hierarchy data structure configured to define a parent node associated with the first user, a first tier node associated with at least a first tier user that has accepted an invitation from the first user, and a second tier node associated with a second tier user that has accepted an invitation from the second user.

11. The method of claim 10, wherein the access control system is configured to set a unique access control setting for the user role for each tier in the hierarchy data structure.

12. The method of claim 11, wherein the network is a genealogical network including a plurality of user IDs organized into a family tree.

13. The method of claim 8, further including a displaying a plurality of networks based on the received user ID and displaying relationships between networks within the plurality of networks.

14. The method of claim 13, further including displaying a plurality of networks having a relationship with the selected network in an interface accompanying the display of the identified social media content items.

15. A computer-implemented method configured to display social media content items using a network based browser, comprising
displaying a plurality of networks from a social media content database, the database including social media content items organized into networks;
receiving a selection of a network from the plurality of networks from a user;
comparing access control information for the selected network including determining role types authorized to view social media content items in the network to a role type associated with the user for that network;
identifying a plurality of social media content items that can be displayed on the comparison; and
displaying the identified social media content items.

16. The method of claim 15, wherein the displayed plurality of networks are associated with the received user ID.

17. The method of claim 15, wherein the displayed plurality of networks include at least a personal network, a family network, and a group network.

18. The method of claim 17, wherein displaying the family network includes displaying family tree information in a genealogical configuration.

19. The method of claim 15, wherein displaying a plurality of networks includes displaying relationships between networks within the plurality of networks.

20. The method of claim 19, further including displaying a plurality of networks having a relationship with the selected network in an interface accompanying the display of the identified social media content items.
